(19) United States
(12) Patent Application Publication
(10) Pub. No.: US 2011/0027519 A1
(43) Pub. Date: Feb. 3, 2011

(54) PAD STRUCTURE

(76) Inventor: Hui-Mei CHEN, Shulin City (TW)

Correspondence Address: HDLS IPR Services, PO Box 220746, Chantilly, VA, 20153, US

(21) Appl. No.: 12/904,218

(22) Filed: Oct. 14, 2010

Related U.S. Application Data
(63) Continuation-in-part of application No. 11/959,302, filed on Dec. 18, 2007.

(51) Int. Cl. B32B 3/26; B32B 3/06; B32B 3/30; B32B 27/00

(52) U.S. Cl. 428/76

(57) ABSTRACT

A pad structure is composed of a thermoplastic, an inner cloth layer, a buffering high molecular layer and an outer cloth layer. The buffering high molecular layer is enclosed with the inner cloth layer, the outer surface of the inner cloth layer is bonded to the thermoplastic which is further enclosed with the outer cloth layer. After that at least a recess slot is formed on the surface combined as such. The completed pad structure is of excellent properties of softness, slip-proof, air ventilation and heat dissipation. When the pad is bonded to the subject matter for associated use, it can improve the usability of the subject matter and make the user comfortable.

### CROSS REFERENCES RELATED TO THE APPLICATION

This application is a continuation-in-part of U.S. patent application Ser. No. 11/959,302, filed on Dec. 18, 2007.

### BACKGROUND OF THE INVENTION

1. Field of the Invention

The present invention relates to an improved pad structure, and more particularly, to an improved pad structure which has an excellent product applicability of well stuffed buffering property, comfortable soft feeling, good air ventilative and heat dissipation effect especially applicable to serve as a pad for shoes, brassiere, rucksack and bed board and orthosis brace or the like.

2. Description of the Prior Art

The conventional pad is used along with various subjects such as shoes to alleviate impact caused by moving subjects with its elasticity. In case it is applied to protect the user's heels, it can help the user avoid injury to his/her heels caused by continuous abrasive friction between his/her heels and shoes.

However, the conventional pad structure has the following shortcomings which have to be rectified.

1. The non-silicone materials material commonly used by the pad structure is easy to be deformed and contaminated after long time use.

2. In case the silicone rubber is used, it is generally made into a slippery membrane to enclose the pad body. As a result, the pad is hard to fix at its position.

3. When the pad is used to the shoes, rucksack or the like, the pad is liable to bend and deform and gradually reduce its elasticity after a long time use, an additional remedying effort is required to restore its elasticity.

For these defects noticeable on the prior art, an improvement is seriously required.

In view of the foregoing situation, having many years of professional engagement with this field, the inventor of the present invention has plunged into this matter for years to studying and rectifying these defects and finally come up with a movel improved pad structure as provided in this invention to eliminate the defects mentioned above.

### SUMMARY OF THE INVENTION

It is an object of the present invention to provide a pad structure which has good air ventilative and heat dissipation effect, giving user a comfortable soft feeling yet without worry of slipping.

It is another object of the present invention to provide a pad structure which can give the user an easy and comfortable feeling no matter using how long time without being deteriorated.

It is one more object of the present invention to provide a pad structure which can be formed into a variety of sizes wide applicable for every usage with low production cost. To achieve the aforesaid objects, the present invention provides an improved pad structure which is selectively composed of buffering high molecular layer, an inner cloth layer, a thermoplastic, and an outer cloth layer. Wherein an inner surface of the inner cloth layer is attached with a buffering high molecular layer, and an outer surface thereof is covered with a layer of the thermoplastic, and the outer surface of the thermoplastic is bonded to the outer cloth layer so as to enclose all of above layers. After that at least a recess slot is formed on the upper surface of the finished product.

To achieve the aforesaid objects, the present invention is composed of a buffering high molecular layer, an inner cloth layer, and a thermoplastic. Wherein the inner cloth layer enclosed the buffering high molecular layer, and the outer surface of the inner cloth layer is bonded to a thermoplastic so as to enclose all of the aforesaid layers. After that at least a recess slot is formed on the upper surface of the finished product.

To achieve the aforesaid objects, the present invention provides a sealing member with a buffering high molecular layer, an inner cloth layer, and a thermoplastic, further to this, one of the side surfaces of the sealing member is bonded to an outer cloth layer.

In the improved pad structure formed as such, the thermoplastic is a thermoplastic high molecular film, for example, a PE film or a TPU film.

In the improved pad structure formed as such, the buffering high molecular layer is made of one selected from liquid state silicone gel, liquid state silicone rubber, polyurethane and thermoplastic elastomers.

In the improved pad structure formed as such, the inner or outer cloth layer is made of material one selected from artificial fiber or natural fiber.

In the improved pad structure formed as such, the outer surface of the thermoplastic high molecular film is further enclosed with an outer cloth layer.

In the improved pad structure formed as such, one side of a sealed member made of the buffering high molecular layer, the inner cloth layer and the thermoplastic highmolecular film is further bonded to an outer cloth layer.

In the improved pad structure formed as such, at least one recess slot is formed longitudinally, transversely or in a zig-zagging way.

In belief, it emerges from the above description that the invention has several noteworthy advantages compared with the prior art, in particular:

1. The pad structure made as such has a better softness. Except enclosing the buffering high molecular layer, the inner cloth layer is able to bond to the thermoplastic high molecular film which serves to avoid emerging of the buffering high molecular layer wrapped in the inner cloth layer. The outer cloth layer serves to improved slip-proof effect of the entire pad structure, and the recess slot helps the pad bend easily without deformation and destruction against external force and impact. The pad structure has an excellent effect or air ventilation, buffering and heat dissipation so that its usability and comfortableness are marvelous.

2. It is applicable to serve as a pad for the shoes, brassiere, rucksack and bed-board and orthosis brace to increase comfortableness and release the stress due to long time use of the subject matters.

3. The pad structure can be of various sizes or shape for application.

### BRIEF DESCRIPTION OF THE DRAWINGS

The drawings disclose several embodiments of the present invention which serve to exemplify the various advantages and objects hereof, and are as follows:

FIG. 1A is a three dimensional perspective view of a first embodiment.

FIG. 1B is a cross sectional view along the line A-A of FIG. 1A.

FIG. 2A is a three dimensional perspective view of a second embodiment.

FIG. 2B is a cross sectional view along the line B-B of FIG. 2A.

FIG. 3A is a three dimensional perspective view of a third embodiment.

FIG. 3B is a cross sectional view along the line C-C of FIG. 3A.

FIG. 4A is a three dimensional perspective view of a fourth embodiment.

FIG. 4B is a cross sectional view along the line D-D of FIG. 4A.

### DETAILED DESCRIPTION OF THE PREFERRED EMBODIMENT

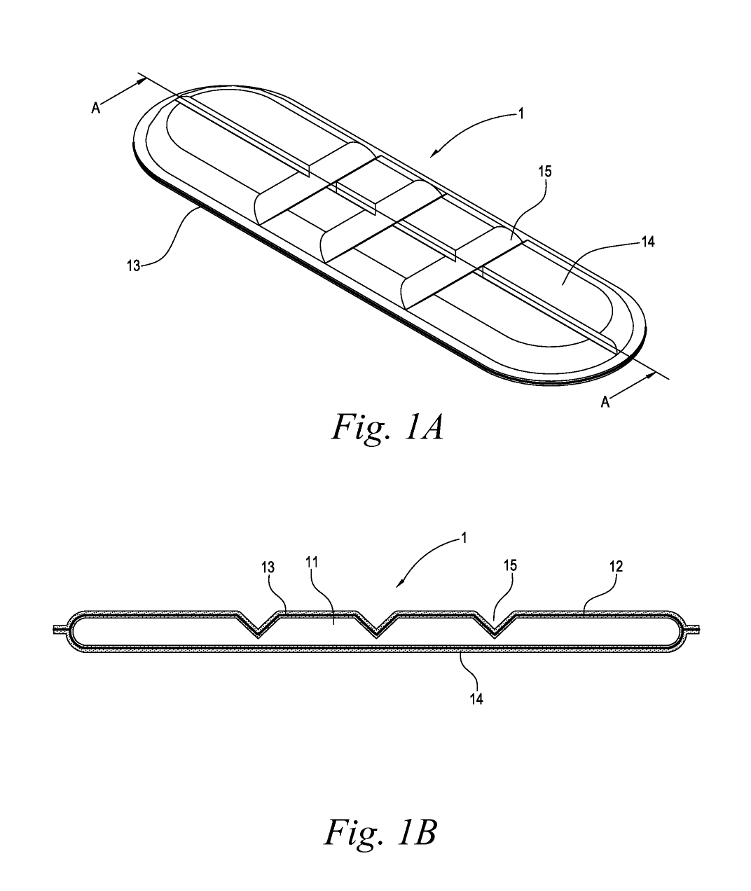

Referring to FIG. 1A and FIG. 1B, in a first embodiment of the present invention, the improved pad structure 1 comprises a buffering high molecular layer 11; an inner cloth layer 12 enclosing the former; a thermoplastic 13 covering the inner cloth layer 12; and an outer cloth layer 14 enclosing the thermoplastic 13, the inner cloth layer 12, and the buffering high molecular layer 11.

Wherein at least a recess slot 15 is formed on the surface thereof after the buffering high molecular layer 11, the inner cloth layer 12, the thermoplastic 13 and the outer cloth layer 14 are combined as such thereby completing formation of the improved pad structure 1.

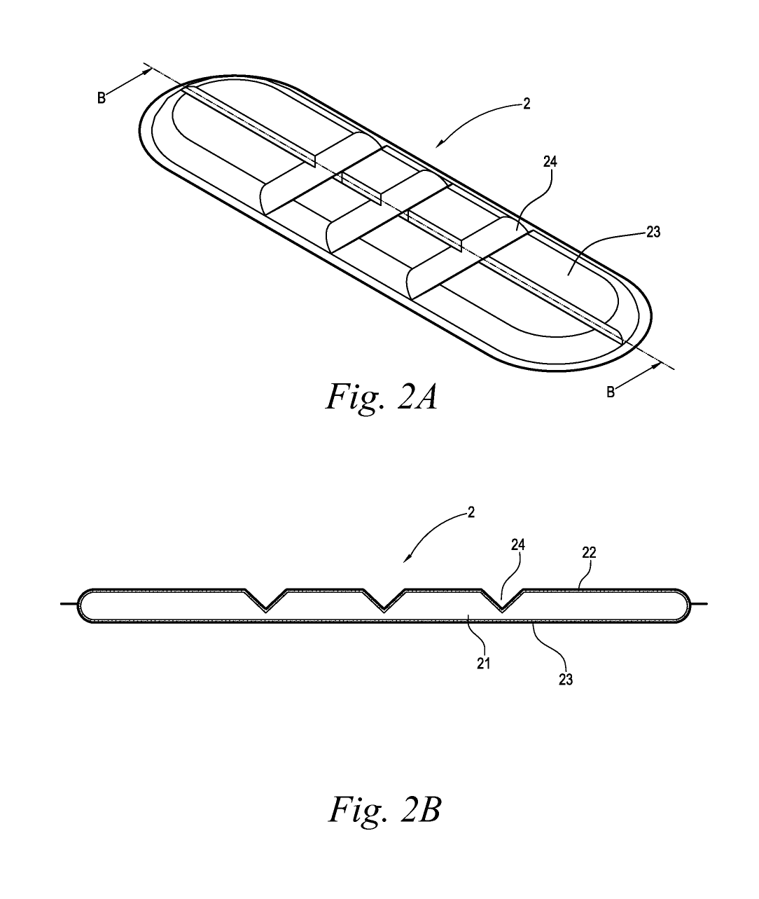

Referring to FIG. 2A and FIG. 2B, in a second embodiment of the present invention, the improved pad structure 2 comprises a buffering high molecular layer 21; an inner cloth layer 22 whose inner surface is bonded to the former; and a thermoplastic 23 whose inner surface is bonded to the outer surface of the inner cloth layer 22.

Wherein at least a recess slot 24 is formed on the surface thereof after the buffering high molecular layer 21, the inner cloth layer 22, and the thermoplastic 23 are combined as such thereby completing formation of the improved pad structure 2.

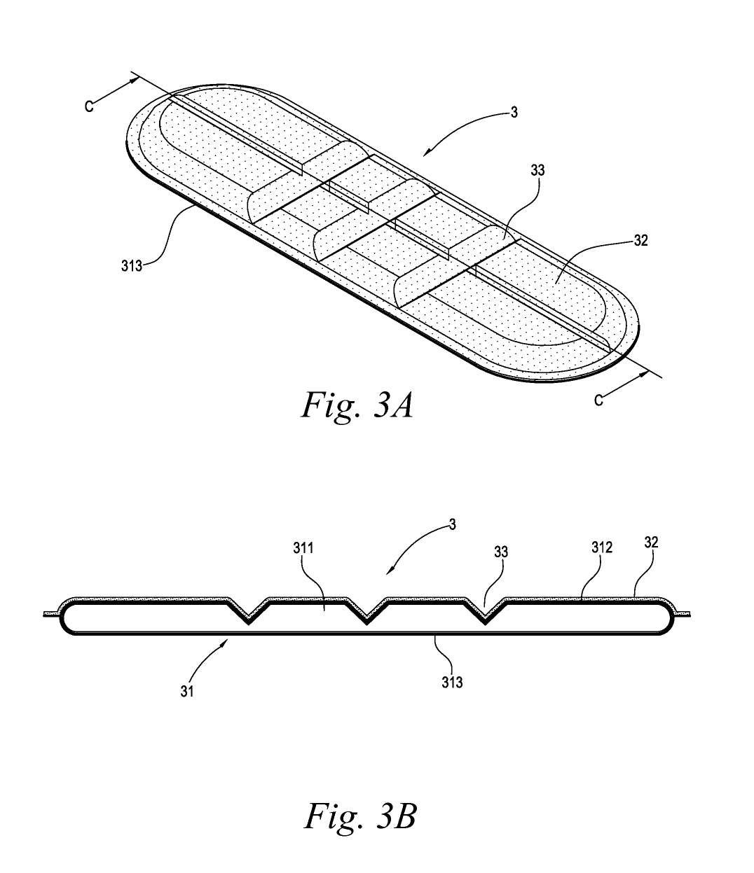

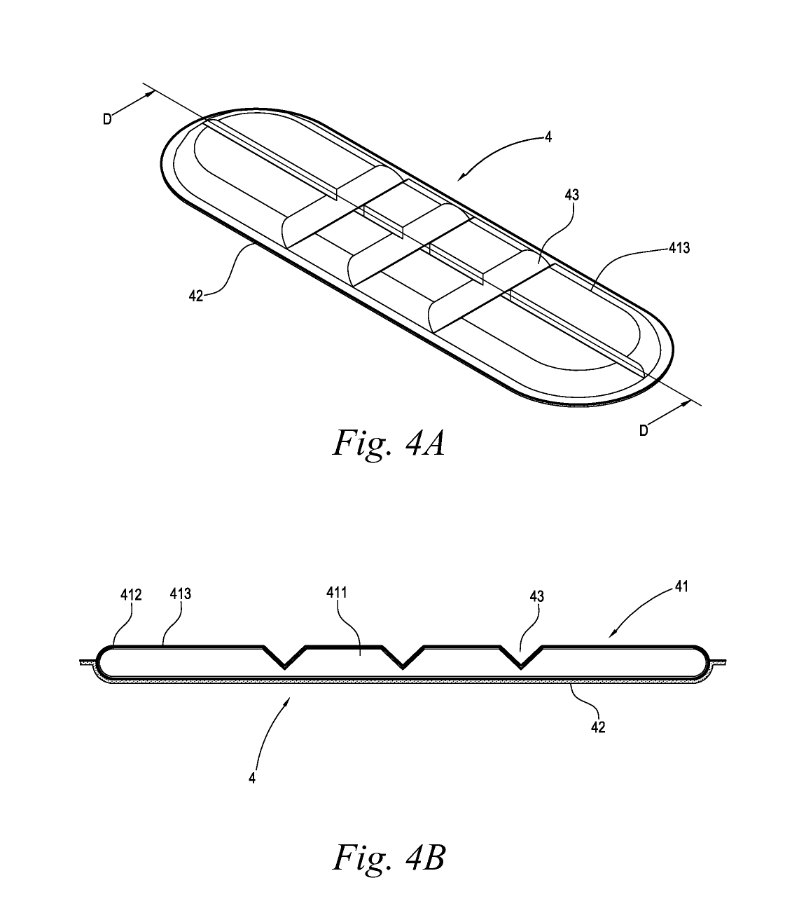

Referring to FIG. 3A, FIG. 3B, FIG. 4A and FIG. 4B, in a third and fourth embodiments of the present invention, each of the improved pad structure 3, or 4 comprises a sealing member 31 or 41 and an outer cloth layer 32 or 42; wherein the sealing member 31 or 41 is composed of a buffering high molecular layer 311 or 411, an inner cloth layer 312 or 412, and a thermoplastic 313 or 413. The buffering high molecular layer 311 or 411 is enclosed with an inner cloth layer 312 or 412, and one of the side surfaces of the inner cloth layer 312 or 412 is bonded to the thermoplastic 313 or 413 with its outer surface. By so, the upper surface of the sealing member 31, or 41 is bonded to the outer cloth layer 32 or 42. After that at least a recess slot 33 or 43 is formed on the surface of the structure thereby completing formation of the improved pad structure 3 or 4.

The above outer cloth layers 14, 32, 42 can be made of a brushy cloth to be adhered to a burred surface such as a magic carpet or the like provided on the subject matter to fix thereon firmly.

The material of buffering high molecular layers 11, 21, 31, 41 used in the above four embodiments is one selected from liquid state silicone gel, liquid state silicone rubber, polyurethane and thermoplastic elastomers, and the inner cloth layers 12, 22, 312, 412 and the outer cloth layers 14, 32, 42 are made of artificial fiber or natural fiber.

Although the present invention has been disclosed and illustrated with respect to preferred embodiments thereof, it is to be understood that the invention is not to be so limited and that other changes and modifications can be made within the full intended scope of the invention as hereinafter claimed.

The present invention is a high level technical creation and by no means simply utilizes conventional technology or knowledge known prior to the application for patent or can easily be made by persons skill in the arts. The invention has neither been published or put to public use, nor displayed in any exhibition, therefore the present invention is entitled to applying patent.

What is claimed is:

1. A pad structure comprising:
a buffering high molecular layer;
an inner cloth layer enclosing said buffering high molecular layer; and
a thermoplastic bonded to the outer surface of said inner cloth layer thereby enclosing said buffering high molecular layer and said inner cloth layer;
wherein at least a recess slot is formed on the surface thereof after said buffering high molecular layer, said inner cloth layer, and said thermoplastic are combined as such.

2. A pad structure comprising:
a buffering high molecular layer;
an inner cloth layer enclosing said buffering high molecular layer;
a thermoplastic enclosing said inner cloth layer; and
an outer cloth layer enclosing said thermoplastic;
wherein at least a recess slot is formed on the surface thereof after said buffering high molecular layer, said inner cloth layer, said thermoplastic, and said outer cloth layer are combined as such.

3. A pad structure comprising:
a sealing member formed of a buffering high molecular layer being enclosed with an inner cloth layer, and further enclosing said inner cloth layer with a thermoplastic; and
an outer cloth layer bonded to the upper surface of said sealing member, and
at least a recess slot being formed on the upper surface of said outer cloth layer.

4. The pad structure of claim 1, wherein said buffering high molecular layer is formed of material one selected from liquid state silicone gel, liquid state silicone rubber, polyurethane, and thermoplastic elastomers.

5. The pad structure of claim 2, wherein said buffering high molecular layer is formed of material one selected from liquid state silicone gel, liquid state silicone rubber, polyurethane, and thermoplastic elastomers.

6. The pad structure of claim 3, wherein said buffering high molecular layer is formed of material one selected from liquid state silicone gel, liquid state silicone rubber, polyurethane, and thermoplastic elastomers.

7. The pad structure of claim 1, wherein said inner cloth layer is formed of material one selected from the artificial fiber, natural fiber, and brushy cloth.

8. The pad structure of claim 2, wherein said inner cloth layer and said outer cloth layer are formed of material one selected from the artificial fiber, natural fiber, and brushy cloth.

9. The pad structure of claim 3, wherein said inner cloth layer and said outer cloth layer are formed of material one selected from the artificial fiber, natural fiber, and brushy cloth.

10. The pad structure of claim 8, wherein said inner cloth layer is made of the brushy cloth to be able to adhere to the Velcro.

11. The pad structure of claim 9, wherein said inner cloth layer is made of the brushy cloth to be able to adhere to the Velcro.

12. The pad structure of claim 1, wherein said recess slot is formed in the longitudinal or transverse direction.

13. The pad structure of claim 2, wherein said recess slot is formed in the longitudinal or transverse direction.

14. The pad structure of claim 3, wherein said recess slot is formed in the longitudinal or transverse direction.

15. The pad structure of claim 1, wherein said recess slot is formed in a zig-zagging way.

16. The pad structure of claim 2, wherein said recess slot is formed in a zig-zagging way.

17. The pad structure of claim 3, wherein said recess slot is formed in a zig-zagging way.

18. The pad structure of claim 1, wherein said thermoplastic is a thermoplastic high molecular film, for example, a PE film or a TPU film

19. The pad structure of claim 2, wherein said thermoplastic is a thermoplastic high molecular film, for example, a PE film or a TPU film

20. The pad structure of claim 3, wherein said thermoplastic is a thermoplastic high molecular film, for example, a PE film or a TPU film
